(19) United States
(12) Patent Application Publication
(10) Pub. No.: US 2006/0097462 A1
(43) Pub. Date: May 11, 2006

(54) Driving mechanism for an adjustable tip assembly

(76) Inventors: Steven M. Moilanen, Fort Wayne, IN (US); Parag Patwardhan, Fort Wayne, IN (US)

Correspondence Address: Barnes & Thornburg LLP, 600 One Summit Square, Fort Wayne, IN, 46802, US

(21) Appl. No.: 11/255,381

(22) Filed: Oct. 21, 2005

Related U.S. Application Data
(63) Continuation-in-part of application No. 11/009,144, filed on Dec. 10, 2004.
(60) Provisional application No. 60/529,361, filed on Dec. 12, 2003.
(60) Provisional application No. 60/550,495, filed on Mar. 5, 2004.
(60) Provisional application No. 60/621,168, filed on Oct. 22, 2004.

(51) Int. Cl. B23B 31/40

(52) U.S. Cl. 279/2.11

(57) ABSTRACT

A clamp configured to grip a workpiece is provided. The clamp has at least one jaw having a tip assembly located thereon that includes at least one tip member selectively adjustable to a plurality of positions relative to the jaw. A driving mechanism configured to selectively hold at least one tip member at a plurality of positions relative to the jaw, is also included. The driving mechanism comprises an actuator and a driver. The driver is moved by the actuator to selectively hold at least one tip member in one of the plurality of positions.

### RELATED APPLICATIONS

The present application claims priority to U.S. Provisional Patent Application, Ser. No. 60/621,168 filed Oct. 22, 2004, entitled DRIVING MECHANISM FOR A COMPLIANT TIP; and is a continuation-in-part of U.S. Utility patent application, Ser. No. 11/009,144 filed on Dec. 10, 2004, entitled ADJUSTABLE TIP ASSEMBLY which claims priority to U.S. Provisional Patent Application, Ser. No. 60/529,361, filed on Dec. 12, 2003, entitled DRIVING MECHANISM FOR AN ADJUSTABLE TIP ASSEMBLY and to U.S. Provisional Patent Application, Ser. No. 60/550,495, filed on Mar. 5, 2004, entitled COMPLIANT TIP ASSEMBLY. The subject matter disclosed in these applications is hereby expressly incorporated into the present application.

### TECHNICAL FIELD

The present disclosure is related to clamps which include adjustable tip assemblies. More particularly, the present disclosure is related to clamps having gripping tips that can selectively adjust to or comply with the irregular surfaces and/or thicknesses of workpieces or successive workpieces of variable thickness, and mechanisms for securing those gripping tips.

### BACKGROUND AND SUMMARY

Clamps and grippers, typically pneumatically powered, can often be used in the sheet metal and other industries to hold, lift, or carry workpieces. Such clamps, however, may be required to grasp a workpiece that has been formed into a particular shape. Conventional prior art tips are permanently formed to the shape of the workpiece that needs to be grasped. There is no flexibility in such a tip, however. This can be problematic if workpieces of different shapes need to be grasped by the same clamp. Consequently, the entire tip must be replaced to grasp a differently shaped workpiece. This is also the case when grasping workpieces of different thicknesses. For example, often the range of travel of the clamp is fixed. Thus, when using conventional tips the clamp would have to be reset to pick up workpieces of different thicknesses. It would, thus, be beneficial to provide a tip assembly that can be configured to grasp workpieces of variable shape.

Accordingly, an illustrative embodiment of the present disclosure provides a clamp configured to grip a workpiece. The clamp comprises at least one jaw having a tip assembly located thereon that comprises at least one tip member selectively adjustable to a plurality of positions relative to the jaw. A driving mechanism configured to selectively hold at least one tip member at a plurality of positions relative to the jaw, is also included. The driving mechanism comprises an actuator and a driver. The driver is moved by the actuator to selectively hold at least one tip member in one of the plurality of positions.

In the above and other illustrative embodiments, the clamp may further comprise: the tip assembly having a plurality of tip members; the driver being movable to hold the plurality tip members; the actuator being engagable with a gear that engages and moves the driver; the driver being engagable with a member that selectively holds the tip member in one of its plurality of positions; the driver being engagable with a plurality of tip members in one of a plurality of positions; the member being a wedge; the actuator being selected from a group consisting of an electric motor, pneumatic actuator, and hydraulic actuator; the contour of the workpiece determining positioning of the tip member at a selected location, and activation of the actuator moves the driver to engage and hold that tip member at the selected location; the tip assembly being attached to the jaw independently of the driving mechanism; and the driving mechanism being coupled to the jaw opposite the tip assembly.

Another illustrative embodiment of the present disclosure provides a method of holding a plurality of tips of a tip assembly attached to a clamp assembly to grip a workpiece. The method comprising the steps of: providing the tip assembly attached to the clamp assembly and the tip assembly comprising a plurality of tips each being independently movable relative to the other; positioning the plurality of tips so they can follow the contour of at least a portion of the workpiece; activating a driving assembly to engage the plurality of tips; locking the tips into position; and gripping the workpiece with the plurality of tip members.

In the above and other illustrative embodiments, the method may further comprise the steps of: engaging the workpiece with the plurality of tips, prior to activating the driving assembly, so the tips can form the contour of at least a portion of the workpiece; and engaging a member with the driving assembly, wherein the member also engages the plurality of tips to lock them into position.

Another illustrative embodiment of the present disclosure provides a clamp assembly that can grip and hold a workpiece. The clamp assembly comprises a jaw, a tip assembly and a drive assembly. The jaw is coupled to the clamp assembly. The tip assembly is coupled to the jaw and comprises a plurality of independently movable gripping fingers. The drive assembly is engagable with the tip assembly, and comprises: an actuator; a drive member; and a gear that translates movement from the actuator to movement to the drive member which is engagable with the plurality of fingers to hold them at a specified position.

Another illustrative embodiment of the present disclosure provides a clamp assembly which comprises a means for gripping a workpiece comprising at least one arm and tip assembly. The tip assembly comprises a plurality of fingers each independently movable relative to the other, and an automated means for locking each of the plurality of fingers once they are positioned in a desired location.

In the above and other illustrative embodiments, the clamp may further comprise the automated means for locking collectively holds the fingers in their desired locations.

Additional features and advantages of the clamp and methods related thereto will become apparent to those skilled in the art upon consideration of the following detailed descriptions exemplifying the best mode of carrying out the clamp and methods related thereto as presently perceived.

### BRIEF DESCRIPTION OF DRAWINGS

The present disclosure will be described hereafter with reference to the attached drawings which are given as non-limiting examples only, in which:

FIG. 1 is a perspective view of an illustrative embodiment of an adjustable tip assembly;

FIG. 2 is a side view of an illustrative clamp assembly comprising illustrative adjustable tip assemblies of FIG. 1 grasping a workpiece of irregular shape;

FIGS. 3a and b are side and detail views of an illustrative clamp assembly with illustrative adjustable tip assemblies of FIG. 1 grasping workpieces of irregular shape in the form of various thicknesses;

FIG. 4 is an exploded view of the illustrative adjustable tip assembly;

FIG. 5 is a rearward perspective view of the illustrative adjustable tip assembly;

FIGS. 6a and b are front and side-cross-sectional views of the adjustable tip assembly of FIG. 4;

FIGS. 7a and b are front and side-cross-sectional views of the adjustable tip assembly of FIG. 4 with a force being applied to a finger;

FIG. 8 is a perspective, partial-cutaway view of the illustrative adjustable tip assembly;

FIGS. 9a and b are end-elevation and side-cross-sectional views of an illustrative housing portion of the adjustable tip assembly;

FIG. 10 is a side view of an illustrative wedge from the adjustable tip assembly of FIG. 4;

FIG. 11 is a side view of an illustrative finger from the adjustable tip assembly of FIG. 4;

FIGS. 12a and b are top-facing and side views of an illustrative spreader from the adjustable tip assembly of FIG. 4;

FIG. 13 is an exploded perspective view of another illustrative embodiment of the adjustable tip assembly;

FIGS. 14a and b are forward and rearward perspective views of the illustrative adjustable tip assembly of FIG. 13;

FIGS. 15a and b are top and side-cross-sectional views of an illustrative wedge from the adjustable tip assembly of FIG. 13;

FIGS. 16a and b are top-facing and side-cross-sectional views of the illustrative housing from the adjustable tip assembly of FIG. 13;

FIGS. 17a and b are top-facing and side views of an illustrative spreader of the adjustable tip assembly of FIG. 13;

FIGS. 18a through c are top-facing, side, and side-cross-sectional views of another illustrative embodiment of a wedge for use in the adjustable tip assembly;

FIGS. 19a-c are left and right perspective views of a clamp assembly showing an illustrative embodiment of a driving mechanism for each adjustable tip assembly;

FIG. 20 is an exploded view of an illustrative embodiment of a driving mechanism along with an adjustable tip assembly and illustrative jaw arm;

FIG. 21 is a downward-looking view of an illustrative clamp jaw with an illustrative driving mechanism and adjustable tip assembly attached thereto; and

FIG. 22 is a cross-sectional view of a portion of the jaw and adjustable tip assembly with the driving mechanism coupled thereto, taken along lines A-A of FIG. 20.

Corresponding reference characters indicate corresponding parts throughout the several views. The exemplification set out herein illustrates embodiments of the clamp, adjustable tip assemblies and driving mechanisms, and such exemplification is not to be construed as limiting the scope of the clamp and adjustable tip assemblies in any manner.

### DETAILED DESCRIPTION OF THE DRAWINGS

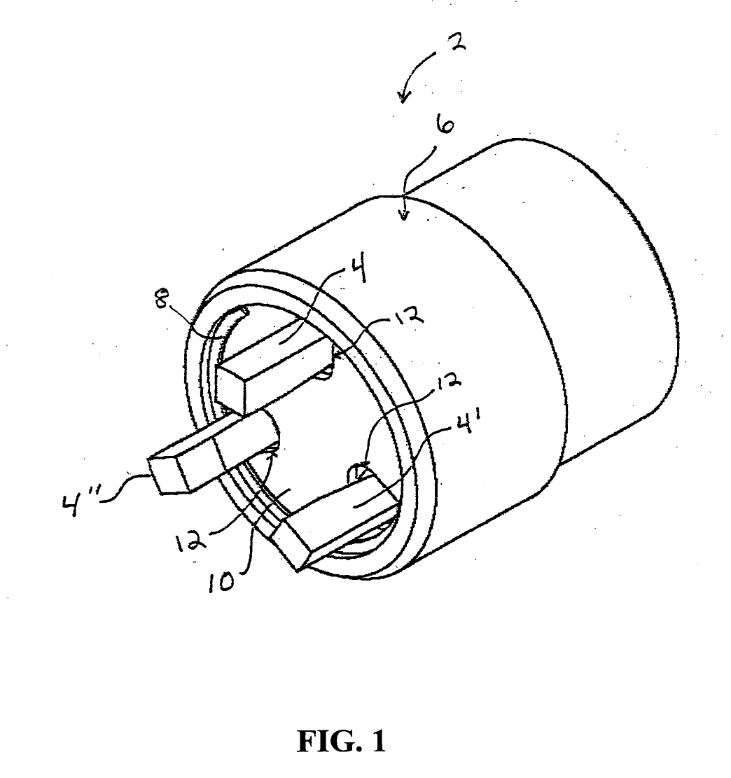

A perspective view of an illustrative embodiment of an adjustable tip assembly 2 is shown in FIG. 1. Shown in this illustrative embodiment, fingers 4, 4′, and 4″ extend from a housing 6. As shown, a retaining ring 8 holds cover 10 within housing 6 while allowing fingers 4, 4′, and 4″ to be disposed therethough at openings 12. Each of the fingers is independently movable to engage a workpiece having an irregular or variable surface. The fingers can then be locked simultaneously into the desired position. The same tip assembly can be reconfigured to engage and grip a workpiece having another irregular or variable surface.

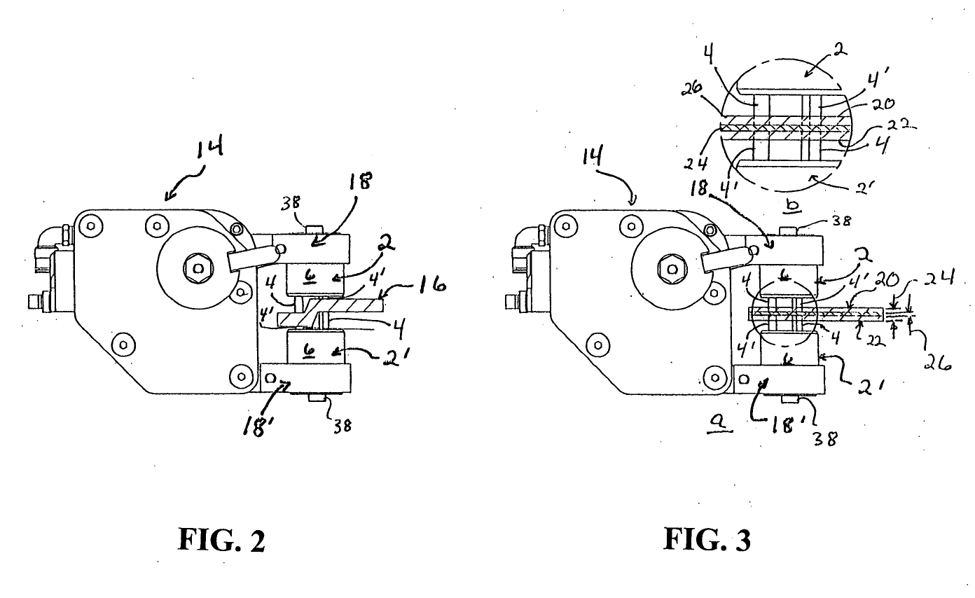

A side view of an illustrative clamp 14 comprising the adjustable tip assemblies 2 and 2′ gripping a workpiece 16 having an irregularly contoured surface is shown in FIG. 2. Finger 4 of adjustable tip assembly 2 is configured to extend while finger 4′ of adjustable tip assembly 2′ retracts. Finger 4″ (not shown in this view) likewise engages workpiece 16. Similarly, finger 4 of adjustable tip assembly 2′ is configured to extend while finger 4′ of adjustable tip assembly 2 is retracted. Consequently, the fingers follow the irregular contour surface of the workpiece. Also shown in this illustrative embodiment are jaw arms 18 and 18′ grasping housing 6 of tip assemblies 2 and 2′. It is appreciated that assemblies 2 and 2′ can attach to a clamp or gripper by any suitable manner. It is further appreciated that clamp 14 can be a pivoting clamp, a parallel moving jaw clamp, or similar gripper.

Another side view of clamp 14 is shown in FIGS. 3a and b. Specifically, FIG. 3a shows adjustable tip assemblies 2 and 2′ being configurable to grasp either workpieces 20 and 22. Each of the workpieces 20 and 22 have a different thickness as indicated by reference numbers 24 and 26 respectively. When grasping workpiece 20, fingers 4, 4′, and 4″ all engage the surface of workpiece 20, as does fingers 4, 4′, and 4″ of tip assembly 2′. In an illustrative embodiment, fingers 4, 4′, and 4″ are reconfigurable so they can also grasp subsequent workpieces of different thicknesses. For example, workpiece 20 having a thickness indicated by reference numeral 26 can also be grasped by fingers 4, 4′, and 4″, without replacement thereof. As shown in the detailed view of FIG. 3b, workpiece 20 is being grasped by fingers 4, 4′, and 4″ on both tip assemblies 2 and 2′. Shown in phantom, are fingers 4, 4′, and 4″ of both tip assemblies 2 and 2′ engaging the workpiece 22 having the lesser thickness 26.

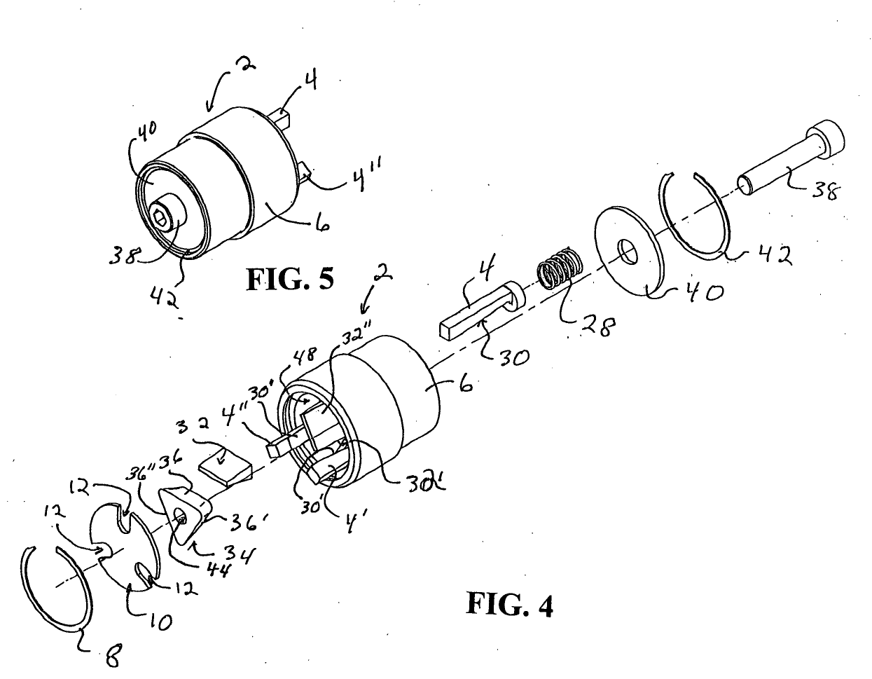

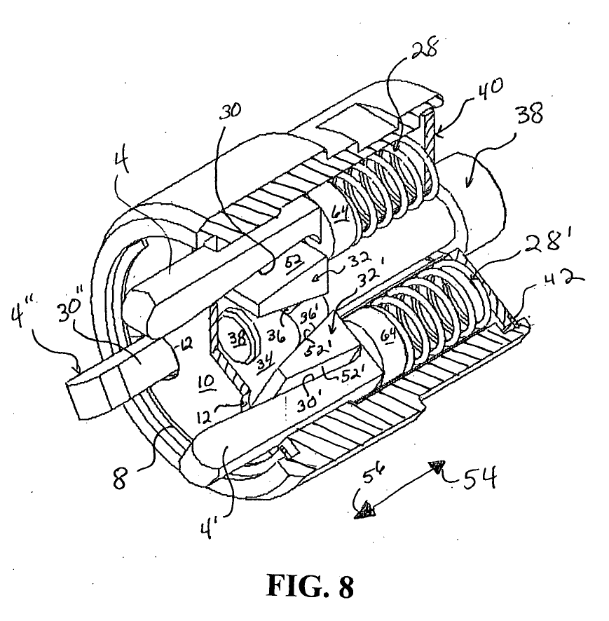

An exploded view of adjustable tip assembly 2 is shown in FIG. 4. This illustrative embodiment comprises fingers 4, 4′, and 4″ each partially located within housing 6. Each of the fingers 4, 4′, and 4″ also engage a corresponding spring 28 and 28′. (See also FIG. 8.) Fingers 4, 4′, and 4″ also comprise an illustrative angle surface 30, 30′, and 30″. These angled surfaces are configured to engage a corresponding angled surface on wedges 32, 32′, and 32″. A spreader 34 comprises angled surfaces 36, 36′, and 36″. The angled surfaces of spreader 34 are configured to engage the opposing surface of each wedge 32, 32′, and 32″. A fastener 38 is disposed through washer 40 and retaining ring 42. The fastener 38 is configured to engage spreader 34, illustratively bore 44, to tighten or loosen spreader 34. This tightening and loosening of spreader 34 holds and releases fingers 4, 4′, and 4″. Cover 10 caps spreader 34 and the other internal structures within housing 6. Openings 12 in cover 10 allow fingers 4, 4′, and 4″ to extend therethrough. Retainer ring 8 holds cover 10 to housing 6.

A rearward view of adjustable tip assembly 2 is shown in FIG. 5. This view shows the position of fastener 38, washer 40, and retaining ring 42 with respect to housing 6. Also shown are fingers 4, and 4″. It is appreciated that fastener 38 is configured to tighten or loosen spreader 34 to allow adjustment of fingers 4, 4′, and 4″. It is further appreciated other fasteners may be configured to accomplish this task, and that the fastener shown herein is an illustrative embodiment. In addition, this illustrative embodiment shows access to the fastener for adjusting means located exterior of housing 6. It is appreciated, however, that other mechanisms of adjustment and access thereto can be used.

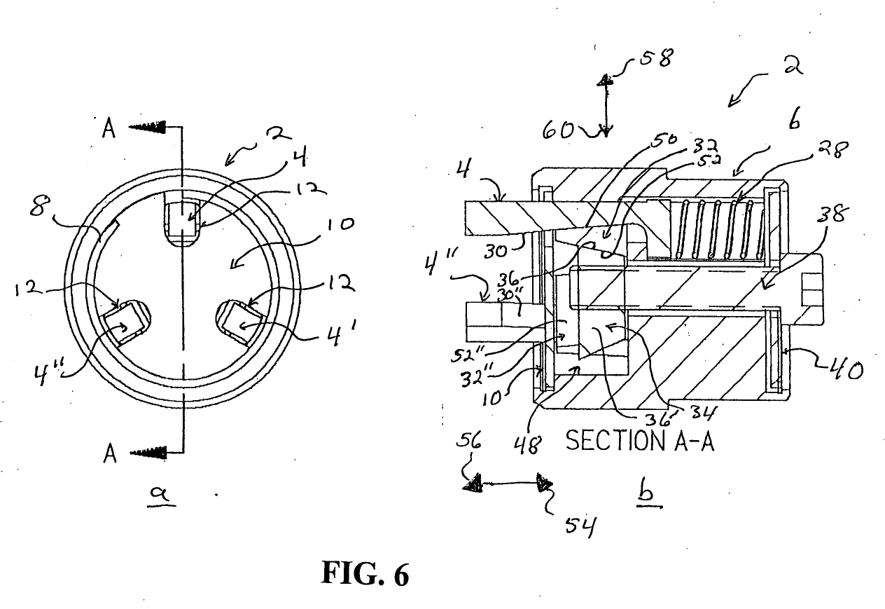

A front view and side-cross-section view of adjustable tip assembly 2 is shown in FIGS. 6a and b, respectively. The forward view of assembly 2, as shown in FIG. 6a, discloses the illustrative position of fingers 4, 4′, and 4″ with respect to each other. Cover 10 is illustratively located over spreader 34 (not shown in this view) and is configured to prevent dirt and contaminants from entering housing 6 during the operation of tip assembly 2. It is appreciated that other configurations of the fingers, and/or cover, fall within the scope of this disclosure.

The side-cross-sectional view of the assembly 2 in FIG. 6b is taken along lines A-A of FIG. 6a. This view shows the interaction and attachment of the several components of assembly 2 with respect to each other. Illustratively, finger 4 positioned within cavity 48 of housing 6 comprises angled surface 30. Illustratively, angled surface 30 of finger 4 is configured to abut the angled surface 50 of wedge 32. Opposite surface 52 of wedge 32 is configured to engage surface 36 of spreader 34. Fastener 38 is illustratively disposed through spreader 34 such that, as fastener 38 is rotated, it draws spreader either inward in direction 54 or outward in direction 56. Spring 28 engages finger 4 and washer 40 and is configured to bias the fingers in direction 56. Springs 28 through 28″ bias against the force created by the workpiece on the fingers so they can be positioned to conform to that workpiece's shape. As spreader 34 is drawn in direction 54, the engagement between surfaces 36 and 52 of spreader 34 and wedge 32, respectively, and finger 4 create opposing forces in directions 58 and 60. These opposing forces prevent finger 4 from moving. It is appreciated that this same mechanism (wedge effect) operates on fingers 4′ and 4″ as well. This opposing force from spreader 34 against the wedges 32, 32′, and 32″ and against all of the fingers 4, 4′, and 4″ keep them in a held or locked position.

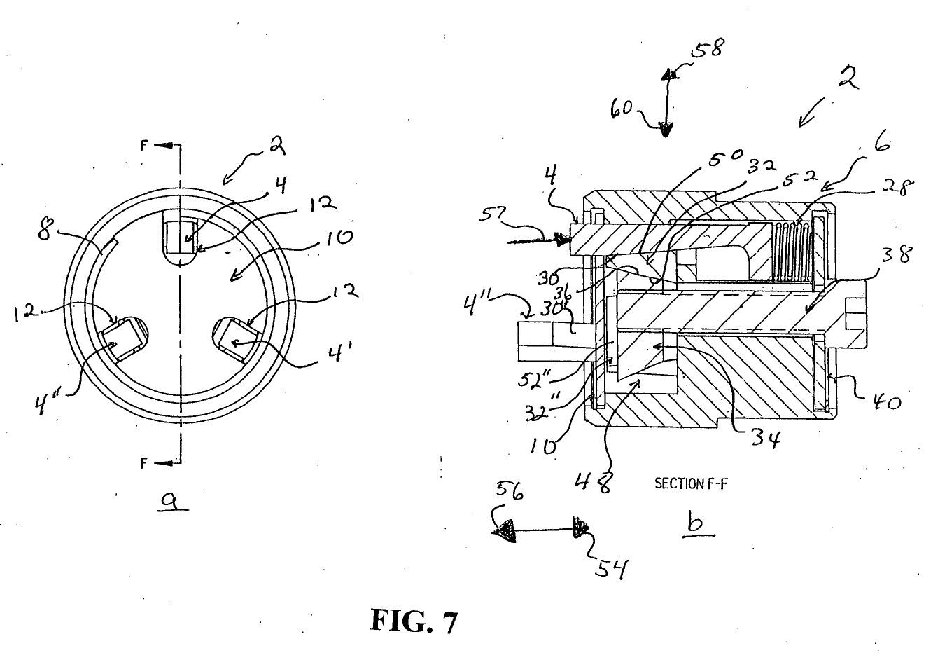

Another front view and side-cross-section view of adjustable tip assembly 2 is shown in FIGS. 7a and b, respectively. Similar to view in FIG. 6a, the forward view of assembly 2 of FIG. 7a, discloses the illustrative position of fingers 4, 4′, and 4″ with respect to each other. Cover 10 is illustratively located over spreader 34 (not shown). The side-cross-sectional view of the assembly 2 in FIG. 7b is taken along lines F-F of FIG. 7a. This view is similar to that shown in FIG. 6b, except that a force 57 is applied to finger 4. It is appreciated that tip assembly 2 can engage a workpiece for holding the same in a clamp with disproportionate amount of force applied to the individual fingers. As shown here, finger 4 has a force 57 applied thereon that is not applied to finger 4″. When fastener 38 loosens spreader 34, the fingers are allowed to move within cavity 48 in directions 54, 56. This movement allows the fingers to conform to the irregular surface or variable thickness of a contacting workpiece. Fastener 38 can then tighten which applies a force against the wedges and fingers to hold those fingers in the conforming shape. The springs 28 ensure that the fingers remain engaged to the workpiece surface during this setting process. Once the fingers are set in position, the workpiece can be removed from the fingers. These fingers, however, maintain their conforming position. This allows a workpiece of the same or similar irregular shape to be grasped. If a workpiece with different irregular shape is to be grasped, tip assembly 2 does not have to be replaced. Rather, the aforementioned process is simply repeated.

A perspective partially cutaway view of adjustable tip assembly 2 is shown in FIG. 8. This view shows the engagement between fingers 4, 4′, and 4″ and wedges 32, 32′, 32″ with spreader 34 and springs 28, 28′, 28″. In this illustrative embodiment, each of the angled surfaces 52, 52′, and 52″ of wedge 32, 32′, 32″, respectively, engage corresponding surfaces 30, 30′, 30″ of the fingers 4, 4′, and 4″. The surfaces 36, 36′, and 36″ of spreader 34 engage the angled surface 52, 52′, 52″ of wedges 32, 32′, 32″, respectively, to cause the same to create the wedge force between the spreader and the fingers. As fastener 38 draws spreader 34 in direction 54, wedges 32 through 32″ are forced against fingers 4 through 4″, securing or holding the fingers in place against the inner wall of housing 6. Because each finger is engagable with its own spring 28 through 28″, adjustable tip assembly 2 can engage and conform to a workpiece having any irregular shape before fastener 38 is tightened in direction 54. The contour of the workpiece creates the force 57 opposite the bias of the spring allowing each finger to engage the workpiece regardless of its contour. (See, also, FIG. 7.) Once the position of the fingers is set, fastener 38 can be tightened to hold fingers 4 through 4″ in position against the contour of the workpiece.

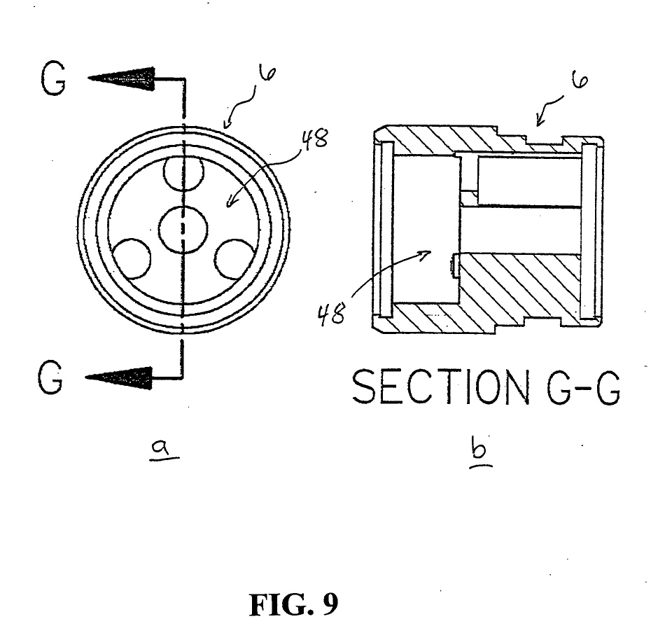

Front and side-cross-sectional views of an illustrative embodiment of housing 6 is shown in FIGS. 9a and b. This illustrative embodiment shows cavity 48 that receives the fingers, springs, spreader, and fastener. It is appreciated that the housing can be configured to contain any number of fingers of any variety or configuration.

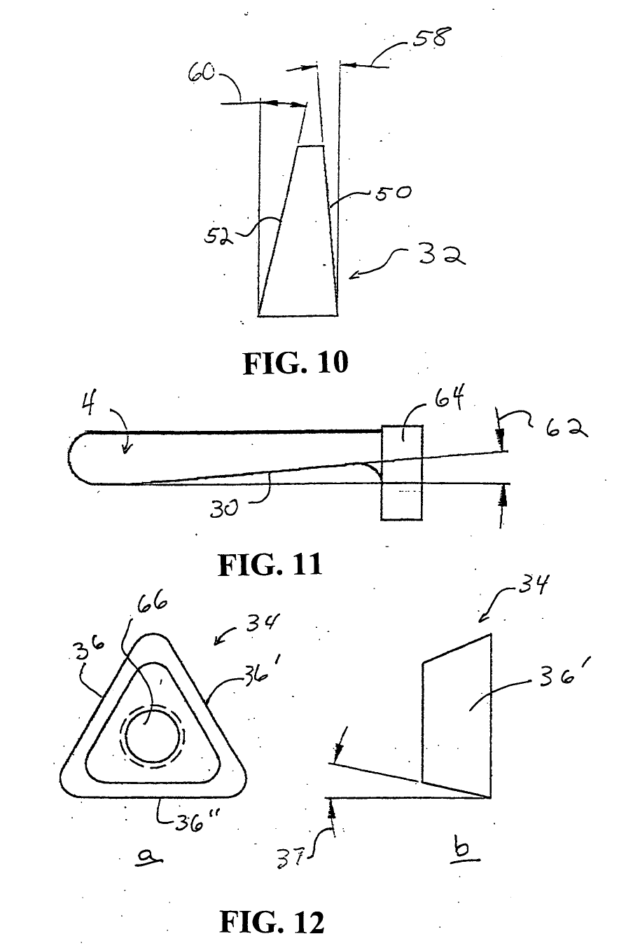

A side view of an illustrative wedge 32 is shown in FIG. 10. In this illustrative embodiment, the angles of surfaces 50 and 52 are indicated by reference numerals 58 and 60, respectively, and are about 5 degrees and 12 degrees, respectively, with an illustrative tolerance of about plus or minus 0.5 degrees. These angles are suitable to create the necessary wedging effect as desired when engaging the spreader and the finger. It is appreciated that the angles 58 and 60 can be varied depending on the configurations of the fingers and the lock or spreader that wedge 32 is positioned between. It is further appreciated that wedges 32′ and 32″ can have the same or different configuration as described herein for wedge 32.

A side view of an illustrative finger 4 is shown in FIG. 11. This illustrative finger has an angled surface 30, as indicated by reference numeral 62, that measures about 5 degrees with a tolerance of about plus or minus 0.5 degrees. In this illustrative embodiment the 5 degree angle is complimentary to the angle 58 of surface 50 of wedge 32. It is appreciated, however, that the degree of angle can be dependent on the type angle of the wedge being used, as well as the configuration of the finger itself. In addition, a base 64 is shown that is configured to engage spring 28 as shown in FIG. 7, for example. It is further appreciated that the base or other analogous surface can be used to engage a bias member to assist in the engagement of the workpiece.

Top facing and side views of spreader 34 are shown in FIGS. 12a and b. In this illustrative embodiment, as shown in FIG. 12a, spreader 34 is triangularly shaped and includes a center bore 66 to receive the fastener 38, as previously described. Spreader 34 comprises angled surfaces 36 through 36″ that engages surfaces 52 through 52″ of wedges 32 through 32″, respectively. It is appreciated that the shape of spreader 34 is not limited to the triangular shape as shown herein. This shape is so configured to allow spreader 34 to engage each of the fingers of tip assembly 2. Other shapes can be used, such as square, circular, etc., depending on the configuration and number of fingers that are to be engaged. The side view of spreader 34 of FIG. 12b shows angle 37 of sides 36 through 36″. In this illustrative embodiment angle 37 is about 12 degrees with a tolerance of about plus or minus 0.5 degrees. It is appreciated, however, that the surfaces are not limited to that precise angle, nor are they limited to all being identical angles. It is appreciated that the angle or angles of the surfaces may vary depending on the configuration and number of fingers and/or wedges or other locking structures desired.

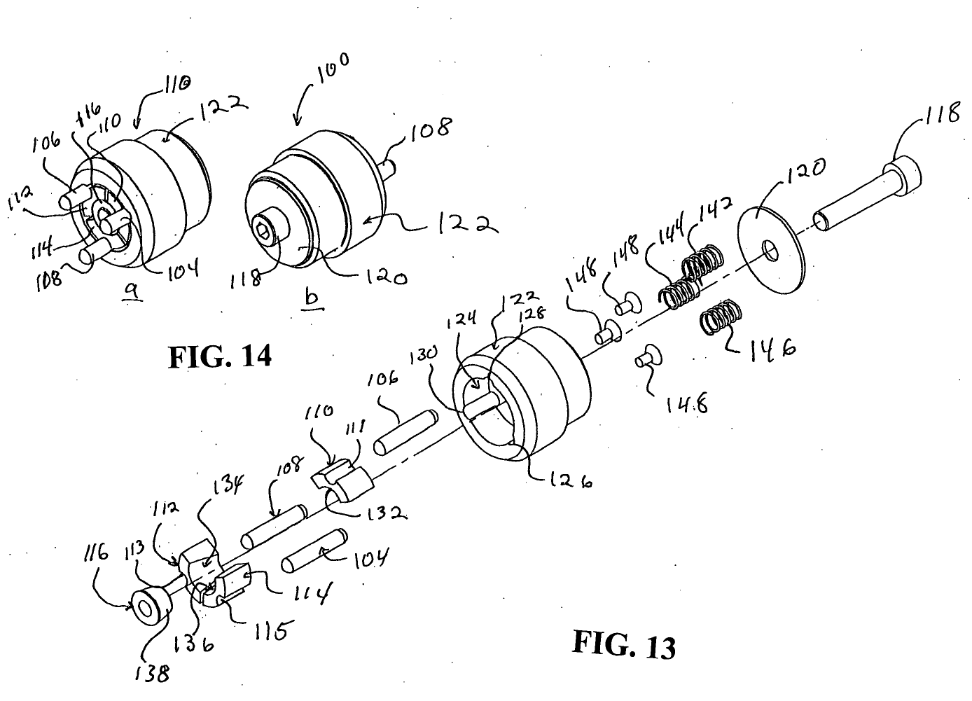

An exploded view of a new embodiment of adjustable tip assembly 100 is shown in FIG. 13. This assembly is distinguishable from assembly 2 in that fingers 104, 106, and 108 of this present embodiment are not angled as they are in assembly 2. Specifically, this view shows housing 122 having cavity 124 that receives fingers 104, 106, and 108 in recesses 126, 128, and 130, respectively. Also fitted within cavity 124 are wedges 110, 112, and 114. These wedges also include recesses 111, 113, 115 that correspond to the shape of the fingers so they are slideable within recesses 126, 128 and 130 of cavity 124. Additionally, wedges 110, 112, and 114 comprise angled surfaces 132, 134, and 136, which, together, form an angle compliment to angle 138 of nut 116. Accordingly, in this embodiment, as angle surface 138 of nut 116 engages angled surfaces 132 through 136, the wedges are drawn outwardly, similar to that described with respect to the wedges 32, 32′ and 32″ of assembly 2 to hold the fingers. Also shown in this view is cap screw 118, washer 120, and springs 142, 144, and 146. These structures operate similar to that described with respect to tip assembly 2. Illustratively, fasteners 148 prevent fingers 104 through 108 from falling out of housing 122. It is appreciated that angled fingers could illustratively be used with wedges of the type shown in this embodiment.

A perspective view of the illustrative adjustable tip assembly 100 is shown in FIG. 14a. Also shown in this view are fingers 104, 106, and 108, and wedges 110, 112, and 114. This view further shows nut 116 that engages wedges 110 through 114. A reverse perspective view of assembly 100, showing cap screw 118 and washer 120, is shown in FIG. 14b.

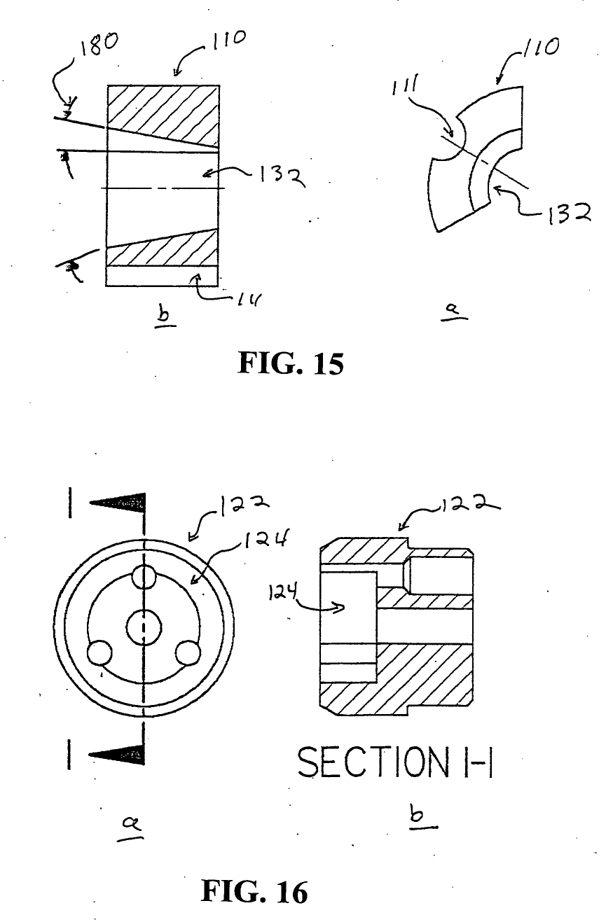

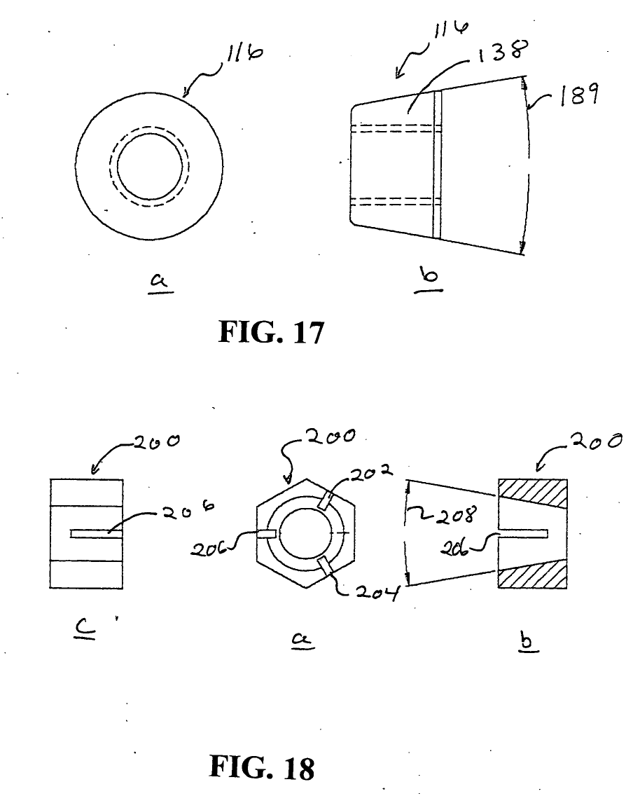

Top and side-cross-sectional views of an illustrative wedge 110, for use on adjustable tip assembly 100, are shown FIGS. 15a and b. It is appreciated that the wedge 110 is the same as wedges 112 and 114, shown in FIG. 13. This view of wedge 110 further shows recess 111, as well as angle surface 132 . The cross-sectional view shown in FIG. 15b also shows recess 111 and angle surface 132. In this illustrative embodiment the angle, indicated by reference numeral 180, is illustratively 10 degrees, or a total of about 20 degrees from opposite angled surfaces. This angle is configured to correspond with the about 20 degree angle indicated by reference numeral 189 of nut 116 shown in FIGS. 13 and 17. It is further appreciated that the angle 180 may vary based on the configuration of the wedge, as well as the nut or spreader. It is still further appreciated that although wedge 32 is “wedge” shaped, in another illustrative embodiment the wedge does not have to be wedge shaped. Rather, its shape can be any shape or configuration that assists in selectively holding a finger or fingers in a desired position.

A front view and side-cross-sectional view of housing 122 are shown in FIGS. 16a and b. These views show cavity 124 disposed within housing 122. The cross-sectional view shown in FIG. 16b is taken along lines I-I of FIG. 16a. It is appreciated that the configuration of housing 122 and cavity 124 can be modified based on the configuration of the fingers, as well as other internal structures.

A front and side view of nut 116 are shown in FIG. 17. The angle of surface 138 is illustratively 20 degrees with a tolerance of about 2 degrees. This angle compliments the angle of surface 132 shown in FIG. 15. It is appreciated that this angle can be adjusted depending on the configuration and number of wedges and fingers. The purpose of the angle is to engage wedge surfaces 132, 134 and 136 and hold fingers 104, 106, and 108 in place once located against the contour of a workpiece.

Top facing, side and side-cross-sectional views of another illustrative embodiment of a wedge 200 are shown in FIGS. 18a through c. In this illustrative embodiment wedge 200 comprises slots 202, 204, and 206. In this illustrative embodiment the slots are configured to allow the wedge, which can be unitary or monolithic, to flex at the sidewalls so a spreader or other locking member can engage wedge 200 to hold the fingers within the tip assembly. Again, the angle of the sidewalls of the wedge, indicated by reference numeral 208, can be any angle that is complimentary to the angle of the spreader or lock that allows the wedge to engage the fingers to hold the same in place.

Another illustrative embodiment of this present disclosure comprises a driving mechanism that may assist holding fingers 4, 4′, 4″ at their desired position. In one embodiment, for example, the driving mechanism can be attached to a jaw arm, such as either arms 18 or 18′ of clamp 14 as shown in FIGS. 2 and 3. In one embodiment the driving mechanism can be configured to automatically lock the fingers into place once they have been positioned to conform to the shape of the workpiece. In another embodiment, a driver, that may serve a purpose similar to that described with respect to fastener 38, can be driven automatically to assist holding or releasing the fingers. Another embodiment is a method of holding such fingers which may include engaging the workpiece with the plurality of finger tips or otherwise positioning the tips so that they can be located appropriately depending on the shape or contour of the workpiece. Once that is accomplished, the driving mechanism can activate to cause the fingers to be held in that desired location. In another illustrative embodiment of this method, the positioning of the fingers can be accomplished by calculating their appropriate position based on some reference or other similar-type means without having to insert and remove a sample workpiece to set the position of the fingers. It is appreciated that the driving mechanism may be used on adjustable fingers that are located on a moving or stationary arm, or other structure. It is further appreciated that the driving mechanism may be useful for one or more adjustable jaw tip assemblies on a given clamp.

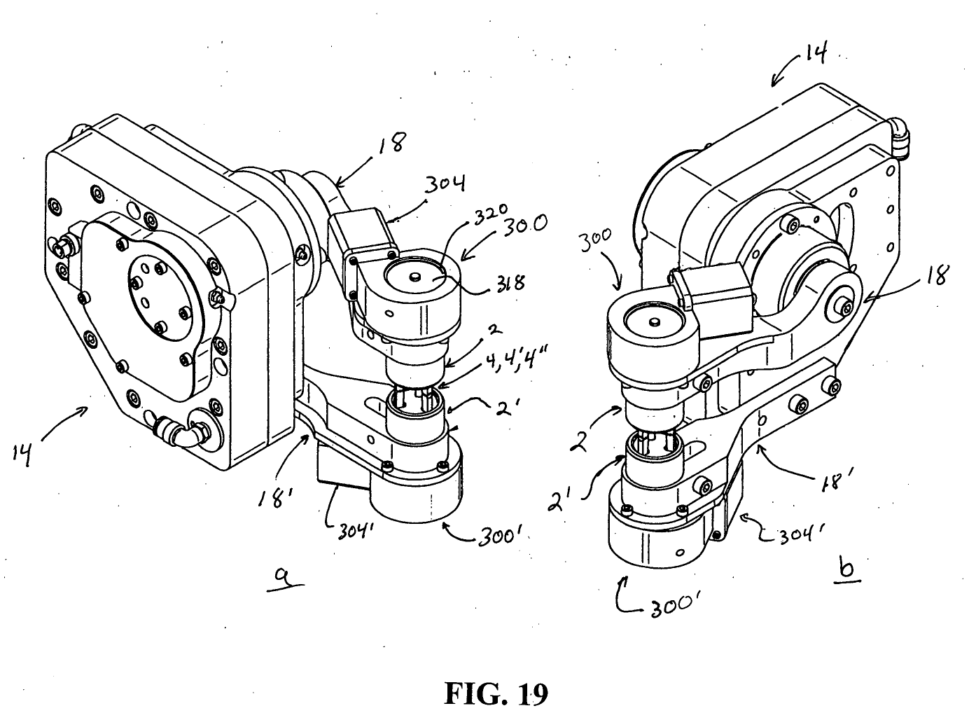

Perspective views of illustrative compliant tip assemblies 2 and 2′ mounted to jaws 18 and 18′ of illustrative clamp 14 are shown in FIGS. 19a and b. These views also show an illustrative driving mechanism assemblies 300 and 300′ comprising actuators 304, 304′ mounted to jaws 18 and 18′, respectively. It is appreciated that mechanisms 300 and 300′ automatically cause fingers 4, 4′, and 4″ to be held in place once they are positioned at the desired location.

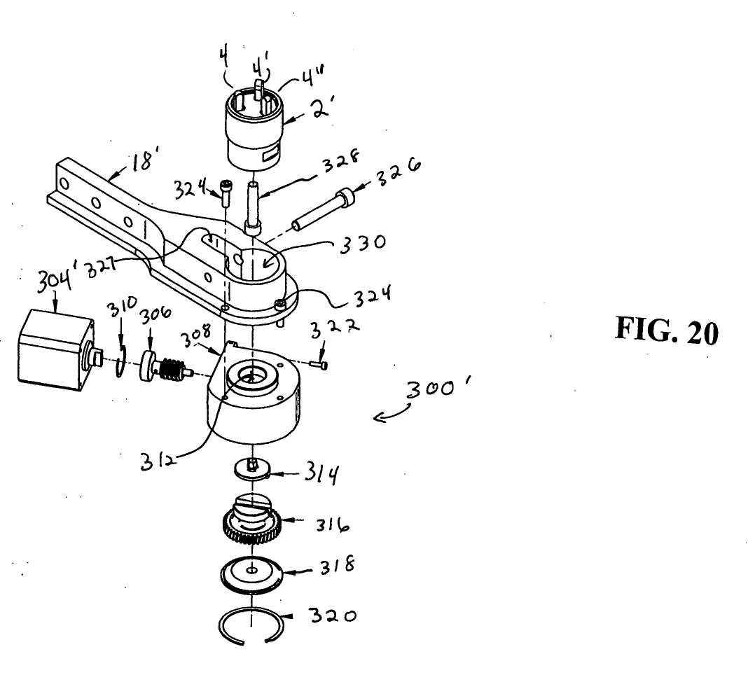

An exploded view of driving mechanism assembly 300′, as well as an illustrative arm 18′ and an adjustable jaw assembly 2′ is shown in FIG. 20. This illustrative embodiment comprises actuator 304′ that is illustratively an electric motor. It is appreciated, however, that in alternative embodiments, the actuator may be a pneumatic or hydraulic cylinder that is configured to drive assembly 300 to assist holding the fingers in place. In the embodiment shown, motor 304′ engages an illustrative worm screw assembly 306 which is disposed within housing 308. A retaining ring 310 can assist maintaining worm screw 306 in housing 308. A bore 312 is shown disposed within housing 308 and is configured to receive a cap screw key 314, worm gear assembly 316, plug 318, and retaining ring 320. Fastener 322 can engage both housing 308 and actuator 304′ to hold the two together. In addition, fasteners 324 can be used to hold housing 308 to arm 18′. Cap screw 326 secures tip assembly 2′ to jaw 18′ by constricting gap 327 and bore 330. Gear plug 318 and retaining ring 320 close bore 312 in housing 308 and retain parts 314 and 316. A driver 328 engages key 314, as well as adjustable tip assembly 2′, by being disposed through bore 330. In one illustrative embodiment, driver 328 can operate similar to that of fastener 38, but is rotated via driving mechanism 300, rather than hand-tightened. In an alternative embodiment, driver 328 is identical to fastener 38. It is further appreciated that the assembly 300′ shown can be employed with tip assembly 2 and/or another adjustable tip assembly mechanism, and with or without arm 18 or other similar-type structure. In this illustrative embodiment assembly 300 is identical to assembly 300′ as are all of the associated structures.

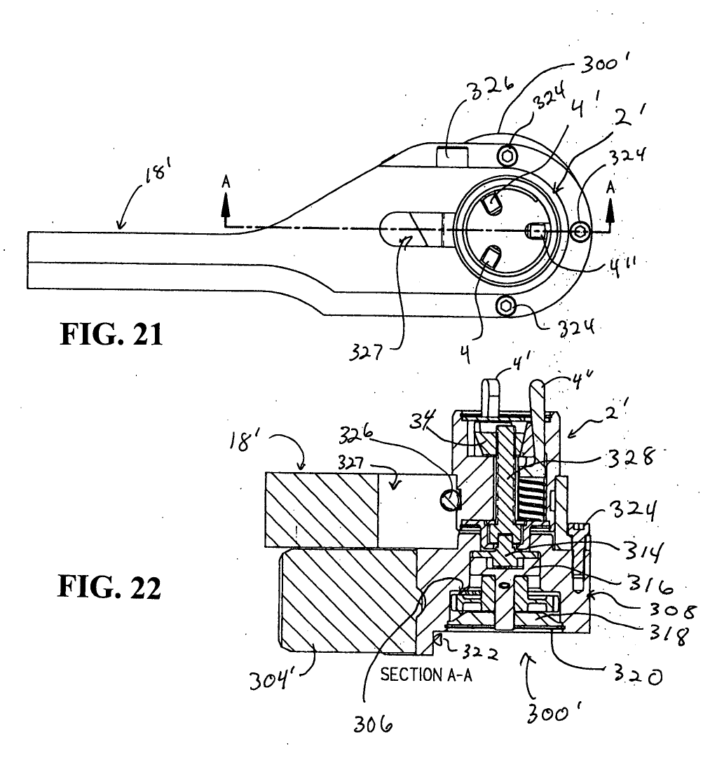

A plan view of assembly 300′ and a cross-sectional view of the same are shown in FIGS. 21 and 22, respectively. The assembly 2′ is shown mounted to jaw 18′, as previously discussed. Specifically regarding FIG. 22, as the motor 304′ rotates, so does worm assembly 306. Cap screw key 314 is positioned in bore 312 of housing 308 and is keyed to worm gear assembly 316. Rotation of worm assembly 306 causes rotation of worm gear assembly 316, thus causing rotation of cap screw key 314. Rotation of cap screw key 314 causes rotation of driver 328, which draws spreader 34 (see FIGS. 4, 6, 7) either inward or outward, similar to that discussed with respect to fastener 38 in the prior embodiments.

It should be noted that this embodiment is not limited to a motor/gear drive mechanism to move driver 328. Manual actuation of the driver may be achieved by keying a wrench into it and rotating by hand. In addition, pneumatic/hydraulic alternatives for actuator 304 may eliminate the need for the gear train (306, 316) altogether. For example, the pneumatic/hydraulic device may be coupled to jaw 18′ in a similar manner to that of housing 308. Driver 328 may be replaced with an extension rod that is integral to a pneumatic/hydraulic device. This extension rod may couple to spreader 34. As the extension rod of the pneumatic/hydraulic device extends, spreader 34 releases force on tips 4, 4′, and 4″, as described in previous embodiments. Conversely, as the extension rod of the pneumatic/hydraulic device retracts, spreader 34 applies force against tips 4, 4′, and 4″, as also described in previous embodiments.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

What is claimed is:

1. A clamp, configured to grip a workpiece, comprising at least one jaw having a tip assembly located thereon that comprises at least one tip member that is selectively adjustable to a plurality of positions relative to the jaw and a driving mechanism configured to selectively hold at least one tip member at a plurality of positions relative to the jaw, the driving mechanism comprising:
an actuator; and
a driver that is moved by the actuator to selectively hold at least one tip member in one of the plurality of positions.

2. The clamp of claim 1, wherein the tip assembly comprises a plurality of tip members.

3. The clamp of claim 2, wherein the driver moves to hold the plurality tip members.

4. The clamp of claim 1, wherein the actuator is engagable with a gear that engages and moves the driver.

5. The clamp of claim 1, wherein the driver engages a member that selectively holds the tip member in one of its plurality of positions.

6. The clamp of claim 5, wherein the driver engages a plurality of tip members in one of a plurality of positions.

7. The clamp of claim 5, wherein the member is a wedge.

8. The clamp of claim 1, wherein the actuator is selected from a group consisting of an electric motor, pneumatic actuator, and hydraulic actuator.

9. The clamp of claim 1, wherein the contour of the workpiece determines positioning of the tip member at a selected location, and activation of the actuator moves the driver to engage and hold that tip member at the selected location.

10. The clamp of claim 1, wherein the tip assembly is attached to the jaw independently of the driving mechanism.

11. The clamp of claim 1, wherein the driving mechanism is coupled to the jaw opposite the tip assembly.

12. A method of holding a plurality of tips on a tip assembly attached to a clamp assembly to grip a workpiece, the method comprising the steps of:
providing the tip assembly attached to the clamp assembly and the tip assembly comprising a plurality of tips each being independently movable relative to the other;
positioning the plurality of tips so they can follow the contour of at least a portion of the workpiece;
activating a driving assembly to engage the plurality of tips;
locking the tips into position; and
gripping the workpiece with the plurality of tip members.

13. The method of claim 12, further comprising the steps of engaging the workpiece with the plurality of tips, prior to activating the driving assembly, so the tips can form the contour of at least a portion of the workpiece.

14. The method of claim 12, further comprising the steps of engaging a member with the driving assembly, wherein the member also engages the plurality of tips to lock them into position.

15. A clamp assembly that can grip and hold a workpiece, the clamp assembly comprising:
a jaw coupled to the clamp assembly;
a tip assembly coupled to the jaw and comprising a plurality of independently movable gripping fingers; and
a drive assembly engagable with the tip assembly, and comprising
an actuator;
a drive member; and
a gear that translates movement from the actuator to movement to the drive member which is engagable with the plurality of fingers to hold them at a specified position.

16. A clamp assembly which comprises a means for gripping a workpiece comprising at least one arm and tip assembly, wherein the tip assembly comprises a plurality of fingers each independently movable relative to the other, and an automated means for locking each of the plurality of fingers, once the fingers are positioned in a desired location.

17. The clamp of claim 16, wherein the automated means for locking collectively holds the fingers in their desired locations.
